(19) United States
(12) Patent Application Publication
(10) Pub. No.: US 2005/0198502 A1
(43) Pub. Date: Sep. 8, 2005

(54) Digital broadcasting system and contents protection method using the same

(76) Inventors: Sang Hoon Cha, Seoul (KR); In Moon Kim, Namyangjoo-si (KR)

Correspondence Address: MCKENNA LONG & ALDRIDGE LLP, 1900 K STREET, NW, WASHINGTON, DC, 20006, US

(21) Appl. No.: 11/068,877

(22) Filed: Mar. 2, 2005

(30) Foreign Application Priority Data
Mar. 5, 2004 (KR) 2004-15172

(51) Int. Cl. H04L 9/00

(52) U.S. Cl. 713/168

(57) ABSTRACT

An authentication method for protecting content transmitted in a digital cable broadcasting system including a headend, a security module and a host. Upon initiation of the authentication method, authentication information is transmitted between the security module and the host. If either the host or the security module authentication information is determined to be invalid the authentication procedure is ended.

This application claims the benefit of Korean Patent Application No. 15172/2004, filed on Mar. 5, 2004, which is hereby incorporated by reference for all purposes as if fully set forth herein.

### BACKGROUND OF THE INVENTION

1. Field of the Invention

The present invention relates to a digital broadcasting system, and more particularly, to an authentication method for protecting cable broadcast content.

2. Description of the Related Art

Digital broadcasting is a general name of digital transmission broadcastings. The United States decided to adopt a next-generation digital television called an advanced television (ATV). Further, in Europe, many projects such as HD DIVINE of Sweden, SPECTRE of United Kingdom, DIAMOND of France and the like are vigorously moving forward. In addition, next-generation digital broadcasting is being vigorously researched in various countries in connection with a Broadband Integrated Services Digital Network (B-ISDN).

Generally, a digital broadcasting stream includes data information together with video/audio signals. The data information is formatted based on the Hyper Text Markup Language (HTML) of the advanced television enhancement forum (ATVEF), the eXtensible Document Markup Language (XDML) of the digital TV application software environment (DASE), and/or Xlet of the DASE.

One of the advantages of digital broadcasts is that a broadcaster can transmit additional information with the program data. This allows a viewer to view a television program while obtaining additional program-related information and/or to purchase goods through a simple manipulation. In addition, a viewer can customize the data so that only information of interest to the viewer is displayed, for example, weather, stocks, news and the like. Some systems also allow customers to perform banking at home. Digital broadcasting also allows for interactive television. Interactive televisions allow customers to take a direct part in live quiz programs, to take an active role by providing a news article or by reflecting their opinion on a broadcasting program.

Digital broadcasting is categorized into three types, terrestrial, satellite and cable each having it's own standards. Digital cable broadcasters, for example, have adopted the Open Cable Applications Platform (OCAP) as the standard for providing Web-services using digital cable broadcasting.

The OCAP is a basic standard for application manufacturer's to provide bi-directional service in cable broadcasting systems. This allows cable broadcasters to provide additional fee based services to cable customers, for example, pay-per-view movies and/or interactive video games. To insure that high value content is not stolen by cable hackers, the content is protected by a conditional access scrambling system.

The conditional access scrambling system comprises a security module that receives the scrambled content, and provides the content to a host upon proper authentication of the module and the host. The security procedures performed by the security module and the host are defined by the Society of Cable Telecommunications Engineers standard SCTE 41 2004.

FIG. 1 is a block diagram illustrating the functionality of a cable broadcasting system. As shown in FIG. 1, the cable broadcasting system includes a cable headend 100, a security module 300, and a host 500. The cable headend represents a cable broadcasting station, the security module represents a cable card, for example, a CableCARD Point of Deployment module, and the host represents a cable television receiver. The security module 300 is referred to as a POD module in the SCTE 41 2004 standard.

The cable headend 300 provides predetermined content, for example, programs, games and/or shopping information, which a customer can view, in the case of programs, or use, in the case of games or shopping information. The security module, as discussed above, is utilized to prevent unauthorized use or copying of high value content. Although the security module is shown in FIG. 1 apart from the host, it is merely for illustrative purposes. The security module can be contained within the host, for example, the host can include a slot for inserting the security module.

According to the SCTE 41 2004 standard, before protected content is provided to the host, it is necessary to verify whether the host is registered (i.e., authorized to receive the protected content) before the contents are provided to the host. Host Authentication is based on the exchange of host and security module certificates between the security module and the host. Each device verifies the other's certificate using signature verification techniques, and the host and security module identifiers (IDs) are reported to the Headend. The Headend compares the IDs against a revocation list and takes appropriate revocation action against compromised devices.

The security module stores a module manufacturer certificate, having a module manufacturer identifier, and a module certificate having a module identifier. When authentication is initiated, a DH-Public Key of the module and a signature of the module certificate are generated. The module manufacturer certificate, the module certificate, the public key of the module and the signature of the module certificate constitute the authentication information for the security module. Proper identifiers are respectively given to a module manufacturer and the security module. Accordingly, the module manufacturer identifier is the proper identifier of the module manufacturer, and the module identifier is the proper identifier of the security module. The host stores a host manufacturer certificate, having a host manufacturer identifier, and a host certificate having a host identifier. When authentication is initiated, a DH-public key of the host and a signature of the host certificate are generated. The host manufacturer certificate, the host certificate, the public key of the host and the signature of the host certificate constitute the authentication information for the host. Proper identifiers are respectively given to a host manufacturer and the host. Accordingly, the host manufacturer identifier is the proper identifier of the host manufacturer, and the host identifier is the proper identifier of the host.

FIG. 2 is a diagram illustrating a portion of the information transmission performed during the authentication procedure by the security module and the host in the cable broadcasting system of FIG. 1. A more detailed description of the entire authentication procedure can be found in the SCTE 41 2004 which is hereby incorporated by reference in its entirety.

The content protection system requires authentication of the host and security module prior to the security module descrambling any protected content. The security module requests the host's authentication information and the host requests the security module's authentication information. As shown in FIG. 2, the authentication information is exchanged between the security module and the host to confirm whether or not the counterpart's authentication information is valid.

When the authentication is initiated, the security module transmits its authentication information to the host 200. The authentication information associated with the security module includes the module certificate, the module manufacturer certificate, the signature of the module certificate, and the DH-public key of the security module. The host verifies the authentication information associated with the security module, and extracts the security module identifier from the module certificate. If the host determines that the authentication information associated with the security module is valid, the host transmits its authentication information to the security module 400. The authentication information of the host includes the host certificate, the host manufacturer certificate, the signature of the host certificate, and the DH-public key of the host. At this time, the authentication result can be displayed on a screen. The host then uses the extracted security module identifier to generate the authentication key of the host and generates its DH-public key.

Meanwhile, the security module verifies the authentication information associated with the host, and extracts the host identifier from the host certificate. If the host's authentication information is valid, the security module generates its authentication key using the extracted host identifier. At this time, the authentication result can be displayed on the screen. The security module then generates its DH-public key. The security module receives the authentication key from the host 600 to confirm whether or not the authentication key of the security module matches with the authentication key of the host.

Additionally, the module identifier, the host identifier and headend information (for example, telephone number) are displayed on the screen.

When the authentication key of the security module is matched with the authentication key of the host, the security module generates a check-point (CP) key to perform the descrambling of a CP-Scrambled Channel. Accordingly, the contents of the headend can be provided to the host.

According to the authentication procedure specified in the SCTE 41 2004 standard, if a counterpart's certificate is valid, the next step is performed, that is, the authentication key and the CP key are generated to perform a descrambling process. However, the authentication procedure does not define the case where the counterpart's certificate is invalid. Accordingly, there is a high possibility that the next step is performed even though the certificate is invalid. Thus, where a hacker hacks the certificate of the security module or the certificate of the host in order to view the contents of the cable broadcasting system without payment, the next step may be normally performed even though the certificate is invalid. Accordingly, there are concerns that a hacker can hack the security module or the host of other users at his/her convenience to enjoy the contents without payment. The related-art content protection method has a drawback in that it can be exposed to hacking, thereby reducing its security reliability.

### SUMMARY OF THE INVENTION

Accordingly, the present invention is directed to a digital broadcasting system and authentication method that substantially obviate one or more problems due to limitations and disadvantages of the related art.

An object of the present invention is to provide a digital broadcasting system and authentication method using the same in which security is reinforced.

Additional advantages, objects, and features of the invention will be set forth in part in the description which follows and in part will become apparent from the description, or may be learned by practice of the invention. The objectives and other advantages of the invention will be realized and attained by the structure particularly pointed out in the written description and claims hereof as well as the appended drawings.

To achieve these objects and other advantages and in accordance with the purpose of the invention, as embodied and broadly described herein, there is provided a digital broadcasting system, including: a host configured to verify first authentication information and to transmit second authentication information in a first authentication process based on the on the verification of the first authentication information; and a security module configured to verify second authentication information in a second authentication process, wherein the first authentication information is transmitted from the security module to the host and if the first authentication is verified to be valid, the host transmits the second authentication information to the security module, else the security module and the host end the first and second authentication processes.

In another aspect of the present invention, there is provided an authentication method for protecting content transmitted using a digital broadcasting system having a security module and a host, the method comprising: transmitting first authentication information from the security module to the host; verifying, in the host, the authentication information of the security module; and if the first authentication information is verified to be valid transmitting second authentication information from the hose to the security module; otherwise, if the first authentication information is verified to be invalid, ending the authentication procedure.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiment(s) of the invention and together with the description serve to explain the principle of the invention. In the drawings:

FIG. 1 is a block diagram of a cable broadcasting system;

FIG. 2 is a diagram illustrating a portion of an authentication procedure performed between a security module and a host in a cable broadcasting system of FIG. 1;

FIG. 3 is a diagram illustrating a portion of an authentication procedure performed between a security module and a host in a cable broadcasting system according to an embodiment of the invention; and

FIG. 4 is a diagram illustrating a portion of an authentication procedure performed between a security module and a host in a cable broadcasting system according to another embodiment of the invention.

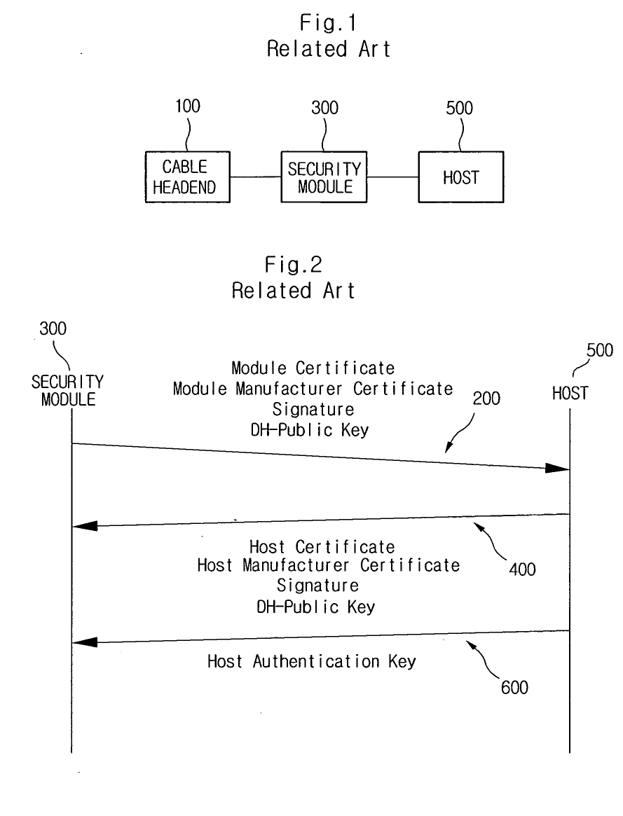

### DETAILED DESCRIPTION OF THE INVENTION

Reference will now be made in detail to embodiments of the invention, examples of which are illustrated in the accompanying drawings.

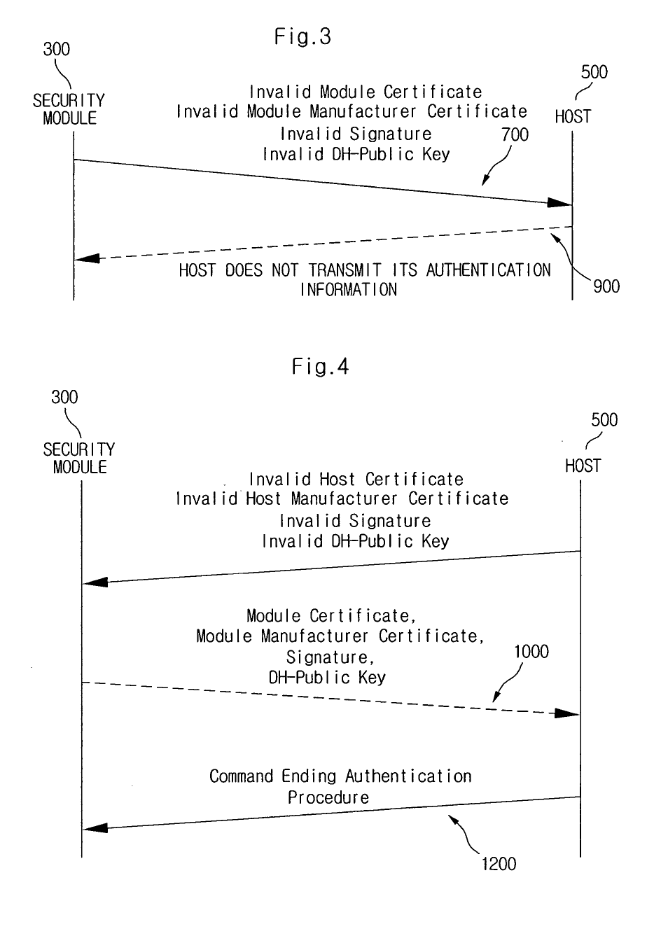

FIG. 3 is a diagram illustrating a portion of an authentication procedure performed by a security module and a host in a cable broadcasting system according to an embodiment of the invention. When authentication is initiated, the security module transmits its authentication information to the host 700. The authentication information associated with the security module includes a module certificate, a module manufacturer certificate, a signature of the module certificate, and a Diffie Hellman (DH)-public key of the security module.

The host verifies the authentication information associated with the security module, and extracts a security module identifier from the module certificate. If the security module's authentication information is valid, the host transmits its authentication information to the security module. However, if the security module's authentication information is invalid, the host displays a message that the authentication information associated with the security module is invalid and does not transmit its authentication information to the security module 900 (represented by the broken line in FIG. 3).

The related-art standard defines only the case where the authentication information of the security module is valid, without defining the case where the authentication information of the security module is invalid. Accordingly, even though the authentication information of the security module is invalid, there is a possibility that the next step in process will still be performed, reducing the reliability of the system. In contrast, the authentication method of the present invention ends the authentication process if the authentication information is found to be invalid. Accordingly, the host does not transmit its authentication information nor does it generate its authentication key and Diffie-Hellman (DH) key.

Furthermore, because the security module does not receive authentication information from the host, the security module will not perform the next step in the authentication process. Accordingly, a hacker is prevented from viewing the protected content.

FIG. 4 is a diagram illustrating a portion of an authentication procedure performed by a security module and a host in a cable broadcasting system according to another embodiment of the present invention. When authentication is initiated, the hosts transmits its authentication information to the security module 800. The authentication information associated with the host includes the host certificate, the host manufacturer certificate, the signature of the host certificate, and the DH-public key of the host.

The security module verifies the authentication information associated with the host, and extracts a host identifier from the module certificate. If the authentication information associated with the host is valid, the security model transmits its authentication information to the host. The authentication information associated with the security module includes the host certificate, the host manufacturer certificate, the signature of the host certificate and the DH-public key of the host.

If the host's authentication information is invalid, the security module displays a message that the authentication information associated with the host is invalid, and ends the authentication procedure. Accordingly, if the authentication information associated with the host is invalid, the security module does not transmit its authentication information to the host, represented by the broken line 1000, nor does the security module generate its authentication key and Diffie-Hellman (DH) key.

In addition, the security module transmits a command 1200 ending the authentication procedure, to the host. Accordingly, the host does not perform the next step in the authentication process, i.e., generating the authentication key and the DH-public key.

In the inventive cable broadcasting system, the security module verifies the authentication information of the host. Additionally, in case where the authentication information of the host is invalid, the authentication procedure is ended. Accordingly, an unauthorized user is prevented from the cable broadcasting system, thereby reinforcing the security performance and improving reliability.

In accordance with the inventive cable broadcasting system, when it is determined that any one of authentication information of the security module and the host is invalid, the next step in to the authentication process is cut off, thereby preventing hacking and enhancing the security of the protected content.

It will be apparent to those skilled in the art that various modifications and variations can be made in the invention without departing from the spirit or scope of the invention. Thus, it is intended that the present invention cover the modifications and variations of this invention provided they come within the scope of the appended claims and their equivalents.

1. A digital broadcasting system comprising:
a host configured to verify first authentication information in a first authentication process and to transmit second authentication information in a first authentication process based on the verification of the first authentication information; and
a security module configured to verify the second authentication information in accordance with a second authentication process, wherein:
the first authentication information is transmitted from the security module to the host, and
if the first authentication information is verified, the host transmits the second authentication information to the security module, else the security module and the host end the first and second authentication processes.

2. A system according to claim 1, wherein the first and second authentication information comprise a device certificate, a manufacturer certificate, a signature and a public key.

3. A system according to claim 1, wherein the host is further configured to:
display a message indicating an invalid authentication if the first authentication information is invalid.

4. An authentication method for protecting content transmitted in a digital broadcasting system having a security module and a host, the method comprising:
transmitting first authentication information from the security module to the host;
verifying, in the host, the first authentication information; and
if the first authentication information is verified transmitting second authentication information from the host to the security module;
otherwise, if the first authentication information is determined to be invalid, ending the authentication procedure.

5. A method according to claim 4, further comprising:
displaying a message that the first authentication information of the security module is invalid if the first authentication information is determined to be invalid.

6. A method according to claim 4, wherein the first authentication information comprises a module certificate, a module manufacturer certificate, a signature of the module certificate, and a public key of the security module.

7. An authentication method for protecting content transmitted using a digital broadcasting system having a security module and a host, the method comprising the steps of:
transmitting first authentication information from the security module to the host;
verifying the first authentication information from the security module in the host;
transmitting second authentication information from the host to the security module if the first authentication information is valid;
verifying the second authentication information from the host in the security module; and
generating an authentication key if the second authentication information is valid; and
ending the authentication procedure if the second authentication information is invalid.

8. A method according to claim 7, further comprising:
displaying a message that second authentication information from the host is invalid if the second authentication information is invalid.

9. A method according to claim 7, wherein the second authentication information comprises a host certificate, a host manufacturer certificate, a signature of the host certificate, and a public key of the host.

10. A method according to claim 7, wherein ending the authentication procedure comprises:
sending a command from the host to the security module to end the authentication procedure.
